(19) United States
(12) Patent Application Publication
(10) Pub. No.: US 2013/0145686 A1
(43) Pub. Date: Jun. 13, 2013

(54) Expandable Plant Support Cage

(71) Applicant: Clyde Dame, LaFontaine, IN (US)

(72) Inventor: Clyde Dame, LaFontaine, IN (US)

(21) Appl. No.: 13/708,234

(22) Filed: Dec. 7, 2012

Related U.S. Application Data
(60) Provisional application No. 61/568,315, filed on Dec. 8, 2011.

(51) Int. Cl. A01G 9/12

(52) U.S. Cl. CPC A01G 9/12
USPC 47/45

(57) ABSTRACT

Disclosed is a plant support device having a wire construction and a rectangular cross section that tapers from an upper region to a base region. The device comprises a plurality of rectangular support members attaching at their corners to upstanding post members forming a wire cage that supports a growing plant within its internal volume. The base region includes a plurality of downwardly elongated stake members that are adapted to be depressed into a soil surface, while a plurality of stake extension members are further provided for elevating the overall structure as the plant grows and requires more elevated support. The extension members are stake members having a stake receiving post and a threaded set screw for securing the extension to the base of each ground stake.

### CROSS REFERENCE TO RELATED APPLICATION

This application claims the benefit of U.S. Provisional Application No. 61/568,315 filed on Dec. 8, 2011, entitled “Tomato Cage.” The patent application identified above is incorporated here by reference in its entirety to provide continuity of disclosure.

### BACKGROUND OF THE INVENTION

1. Field of the Invention

The present invention relates to plant supports and cages. More specifically, the present invention pertains to a tomato plant cage having a rectangular construction to prevent tipping and an expandable set of ground stakes that raise the height of the cage as the plant grows.

Plant supports and nursery cages are devices that have been developed for supporting growing plants while preventing the plants from drooping, leaning or otherwise damaging itself based on its own weight or the weight of elements in its immediate environment. These devices generally employ upstanding support elements that support the limbs and main portion of the plant, while the limbs of the plant may further be supported in an outwardly extended position. This prevents the plant from leaning over and damaging itself, or further preventing heavy fruits from weighing down the plant's limbs such that the fruit rest on the ground or break the limbs altogether. Keeping fruit elevated reduces mold development and also prevents ready access to the fruit to ground pests and insects. Supporting a plant in an upright configuration also improves the exposed surface area of the plant for improved light exposure, which facilitates photosynthesis and growth. Plants are further protected from the weight of rainfall impacts, collected water on limbs, and the weight of accumulated snowfall, which can all weigh down the plant's limbs and cause it to deform if left unsupported.

The present invention discloses a new plant cage and support that is adapted to provide an upstanding support for a growing plant, wherein its structure employs a tapering cross section of rectangular-shaped cross members and upwardly extending support posts. The base of the device includes a plurality of downwardly directed ground stakes, wherein the stakes are adapted to either be entered into the ground surface or into the posts of stake extension members, which are utilized to raise the height of the device as the plant grows and requires more elevated support. The limbs of the plant are supported on the cross members, while the trunk or main stalk of the plant is supported within the interior of the cross members and prevented from leaning or succumbing to the weight of its own structure or external elements.

2. Description of the Prior Art

Devices have been disclosed in the prior art that relate to plant supports and cages. These include devices that have been patented and published in patent application publications, and generally relate to wire structures or supports having various constructions within a limited height range. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,412,905 to Allison discloses a single unit plant protection device comprises an open top cone configuration, a plurality of angularly upstanding portions connected to circular wires that create a circumferential cage around the plant. An insulating blanket is adapted to be connected to the cage to prevent freezing of the plant due to frost, wherein the blanket preferably comprises a green plastic having a plurality of trapped air cells that act as a thermal barrier. The Allison device is adapted to support an insulating blanket, as opposed to providing a rectangular-shaped support that resists tipping and further is expandable.

Another such device is U.S. Pat. No. 3,559,339 to Worley, which discloses a collapsible plant stake assembly, comprising a plurality of corner stakes interconnected by lateral support or side rails. The side rails utilize a connecting means that allow the side rails to pivot thereabout and condense the corner stakes together while aligning the side rails therewith, providing a condensable and collapsible structure. The structure of the Worley device provides a collapsible and readily stowable device when not in use, wherein its deployed state surrounds a plant for support and connection therewith. The present invention does not collapse, but is rather a unitary structure having a rectangular cross section and an expandable lower section to raise the height of the cage while deployed.

U.S. Pat. No. 7,017,299 to Speed discloses a plant supporting structure that comprises a plurality of vertical support posts that are formed along corners of a polygon shape, wherein the posts include apertures therealong. Rods connect between the support posts through the apertures, wherein the assembly forms a means to support a plant within the interior defined by the corner support posts and the boundary rod connectors. The Speed device similarly fails to disclose the novel aspects of the present invention, which discloses an expandable plant support having a rectangular construction. The present invention provides a connected structure that is expandable vertically to accommodate growth of the plant over time while continuing to offer lateral support therefor.

Further, U.S. Published Patent Application Publication No. 2010/0101144 to Kurtz discloses a planter device for upwardly supporting live goods therewithin, comprising an open container connecting to a planter cage frame via a pair of releasably attachable clips. The peripheral edge of the container is adapted to receive the distal ends of the cage legs, while the clips secure the two structures together for a portable, secured plant support device. The Kurtz device discloses a combination planter container for soil and plant roots, wherein the container includes an open upper region and a peripheral lip adapted to support an upstanding planter cage using releasable clips. The present invention relates to in-ground plant supports having a rectangular construction and means of extending the height of the cage after initial deployment using a plurality of extension members.

U.S. Pat. No. 4,667,438 to Corell discloses a tomato cage comprising a plurality of vertical support posts arranged in a polygon around a growing plant. A plurality of shaped rods having a first and second end are positioned between the support posts in a slightly angular fashion, the first end being received by apertures in the support posts and the second ends having a hook portion for engaging an adjacent rod. The assembly is meant for quickly establishing a plant support device without the use of tools or larger assemblies. While providing a readily assemblable device for supporting a plant, the Corell device is one of independent elements that for the cage. The present invention is a singular structure having a rectangular cross section and a means of adding height to the device as the plant grows. No tools or assembly is required for the upper support region of the present invention.

Finally, U.S. Patent Application Publication No. 2003/0066233 to Gunderman discloses a wire plant cage comprising a looped upper portion adapted to accept a growing plant, lower extension portions and a structure that is adapted to accept downward force when being inserted into the ground. The structure is further designed for efficient stacking when not in use. Elongate legs are provided having a first end connected to a loop for supporting the plant and a second end adapted to be pressed into a soil surface. A ledge is formed to allow downward force during soil insertion, while the structure is designed in a stackable configuration when multiple cages of the same shape are stored. The Gunderman device, while providing a stackable and supportive plant cage, differs in design from the present invention, and relates more to a structure that is adapted to accept downward soil insertion forces without the device buckling or yielding. The present invention provides a stable structure of rectangular cross section, wherein the legs are raisable using extension members to accommodate plant growth or taller plants.

The present invention pertains to an extendable plant support device having a rectangular construction and a tapering cross section, wherein the support height is adjustable using a plurality of support post extensions. It is submitted that the present invention substantially diverges in design elements from the prior art, and consequently it is clear that there is a need in the art for an improvement to existing plant support devices. In this regard the instant invention substantially fulfills these needs.

### SUMMARY OF THE INVENTION

In view of the foregoing disadvantages inherent in the known types of plant support devices now present in the prior art, the present invention provides a new extendable plant support wherein the same can be utilized for providing convenience for the user when supporting an upright plant during growth and allowing the user to adjust the height of the support without replacing the original structure.

It is therefore an object of the present invention to provide a new and improved plant support device that has all of the advantages of the prior art and none of the disadvantages.

It is another object of the present invention to provide a plant support device that provides an upright structural support for a plant, wherein the weight of the plant itself, its fruit and limbs are supported such that the plant does not become damaged or stunted.

Another object of the present invention is to provide a plant support device that supports the plant in an upright configuration to improve light contact and prevent fruiting plants from having their fruit close to the ground and accessible to ground pests and mold development.

Yet another object of the present invention is to provide a plant support device that provides an means of extension for raising the height of the support as the plant grows, wherein the ground stakes are removed from the ground and placed in ground stake extensions for greater height.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a view of the ground stake extension members being placed on the ground stakes of the support device.

FIG. 3 shows a perspective view of the present invention in a working position, supporting a plant in an upright configuration.

### DETAILED DESCRIPTION OF THE INVENTION

Reference is made herein to the attached drawings. Like reference numerals are used throughout the drawings to depict like or similar elements of the plant support device. For the purposes of presenting a brief and clear description of the present invention, the preferred embodiment will be discussed as used for providing a sturdy plant support device that is extendable for accommodating the growth of the plant over its deployed use. The figures are intended for representative purposes only and should not be considered to be limiting in any respect.

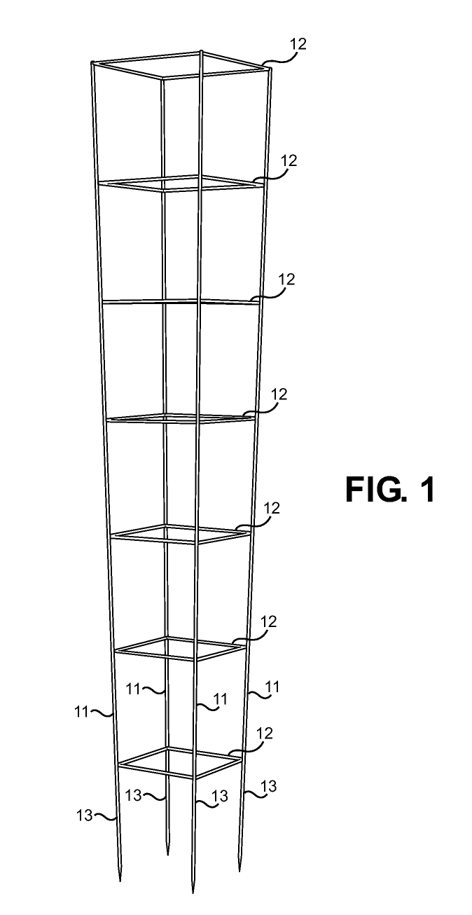

Referring now to FIG. 1, there is shown a perspective view of the plant support device of the present invention. The device comprises a plurality of upstanding support posts 11 that form the corners of the support and the rising members that establish the overall height of the support. Between the upstanding posts 11 is a plurality of horizontally-positioned cross bars 12 that define a rectangular support that surrounds an interior volume within which the plant is positioned. The rectangular supports provide perimeter support for the plant to lean against and further for limbs to be positioned thereover, wherein the limbs are supported and prevented from drooping under their own weight. The upper portion of the device terminates at an uppermost rectangular cross member, while the base of the device includes a plurality of downwardly directed ground stakes 13 that are adapted to be pressed into a soil surface for statically supporting the overall structure and the weight of the plant therein while deployed. The ground stakes 13 are sharpened ends of the upstanding support posts 11, and are adapted to be pressed a significant distance into the ground such that the device is stably supported. The overall cross section of the device is rectangular shaped, wherein an interior volume is provided within the rectangular cross members 12. The volume progressively increases with height, wherein the linear area increases and the posts taper outward from the base to the upper portion. This accommodates larger plant growth in higher elevations along the support.

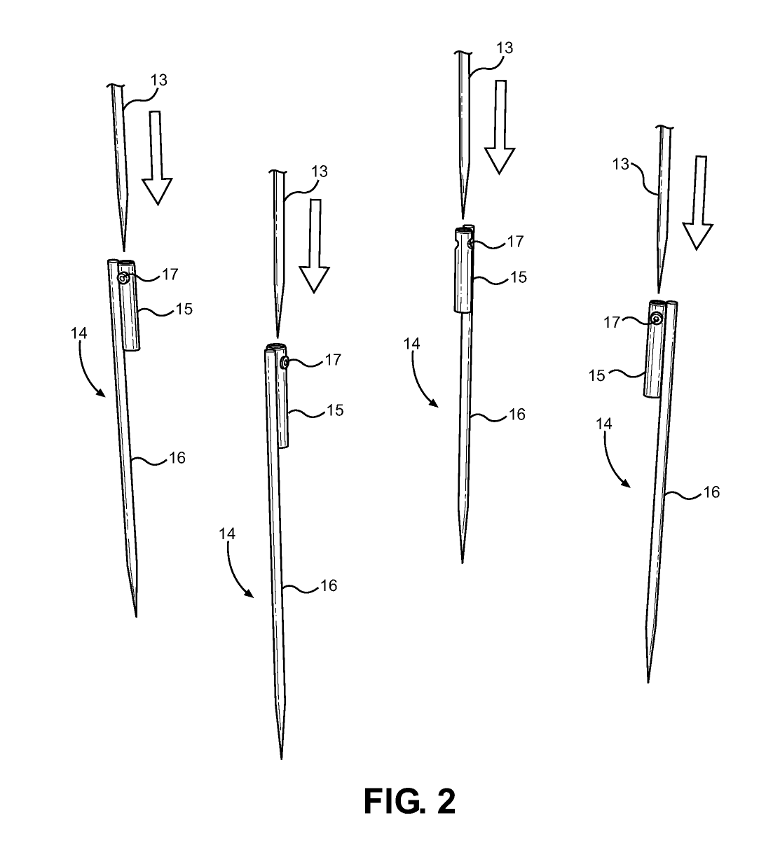

Referring now to FIG. 2, there is shown a close up view of the lower portion of the present device and the ground stake extension members 14 being engaged. The ground stake extension members 14 are members that support the ground stake portions 13 of the support device in an elevated position, wherein the overall plant support can be raised. Successive extensions may be utilized for continually raising the height of the support if desired, which eliminates the need for support cages of differing height. A single support may be raised using the extension members to accommodate large plant growth. Specifically, the extension members comprise elongated stake members 16 having a pointed distal end and proximal end attaching to or terminating at a ground stake accepting post 15. The post 15 is an open support tube having either a closed or open base, and an open upper portion adapted to accept the lower portion 13 of the support device. The lower portion 13 is secured to the post 15 using a set screw 17, which is a threaded screw member that bears against the stake 13 and prevents relative movement thereof with respect to the post. Each of the stake members 13 are connected at once to uniformly raise the height of the support device while in operation, wherein the extension member pointed end is pressed into the soil surface rather than the base members 13 of the support.

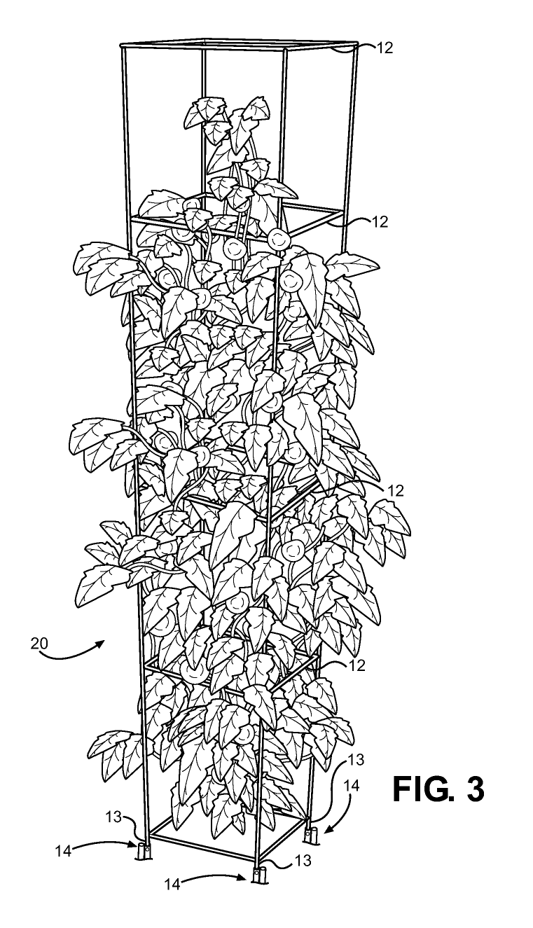

Referring now to FIG. 3, there is shown a perspective view of the present invention in a working position supporting a plant 20 in an upright configuration. The device provides a tapering cross section for the tree or plant to expand, while the support bars 12 provide ledges upon which the branches of the plant and the fruit thereon are sufficiently supported. The interior of the structure provides a cage within which the plant 20 is prevented from leaning or drooping from high winds, rainfall and snow accumulation, and further the weight of the plant itself as it develops fruit or grows excessively larger. To further accommodate the size of the growing plant and to prevent the user from replacing an existing support cage, the ground stakes along the support lower region 13 of the upstanding posts are positioned within the extension members 14 for raising the overall height of the device. The height of the upright posts and number of support bars 12 may vary depending upon application and the intended plant being supported. Those with more dense vegetation or limbs may require more bars 12, while taller and sparser plants may require less frequent bars 12 and taller support posts 11. It is not desired to limit the dimensions or the number of rungs along the support device, but rather to disclose an extendable height support device having a supportive structure adapted to retain and upright plant within its interior.

Without proper support, garden and lawn plants can begin to topple or lean once the fruit starts to grow to full size and become heavy. This is particularly true of tomato plants, which have large fruit development and inadequate structure support therefor. When this happens, the fruit can fall to the ground and rot. Also, the plant can break in strong winds and damage the plant, leaving the farmer, gardener, or grower without a crop to harvest. This can be devastating for those who rely on the tomatoes for food or income. Additionally, if the entire plant falls over onto the ground, it can be difficult for a user to navigate between rows of plants. The present invention provides a means to support a plant such as a tomato plant in an upright and supported position. Each plant can be supported individually and aligned into a grid, improving overall order of a garden and access therethrough. Further, the height of the support can be adjusted using ground stake extension members, eliminating the need for replacement support devices and allowing the user to raise the height of the currently deployed support for the given plant. This reduces time, cost and storage necessities of the user, as replacement supports or supports of varying height are no longer necessary.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An expandable upright plant support device, comprising:
a plurality of upstanding support posts having an upper end and a lower end;
a plurality of aligned cross bars extending between and connecting to adjacent support posts, said cross bars forming an enclosed area along a horizontal plane wherein said posts are the corners of the enclosed area;
at least one set of aligned cross bars being positioned between said upper and lower portion of said support posts;
said upper portion of said support posts terminating with a set of aligned cross bars;
said lower portion of said support posts terminating at a pointed ground stake end;
a set of elongated ground stake extension members comprising a first ground stake end and a second end having a means of accepting said support post lower portion or the stake end of another ground stake extension member;
each member attaching to a support post ground stake end for raising said support posts vertically.

2. The device of claim 1, wherein said aligned cross members form a rectangular cross section with said support members at each corner.

3. The device of claim 1, wherein said upright support posts taper outwardly from said lower portion to said upper portion.
